(19) United States
(12) Patent Application Publication
(10) Pub. No.: US 2006/0220339 A1
(43) Pub. Date: Oct. 5, 2006

(54) Torsion beam type rear suspension

(75) Inventors: Yuki Kusaka, Fuchu-cho (JP); Kazuo Harada, Fuchu-cho (JP)

Correspondence Address: NIXON PEABODY, LLP, 401 9TH STREET, NW, SUITE 900, WASHINGTON, DC, 20004-2128, US

(73) Assignee: MAZDA MOTOR CORPORATION, Hiroshima (JP)

(21) Appl. No.: 11/373,268

(22) Filed: Mar. 13, 2006

(30) Foreign Application Priority Data
Mar. 31, 2005 (JP) 2005-104564
Mar. 31, 2005 (JP) 2005-104565
Mar. 31, 2005 (JP) 2005-104566
Mar. 31, 2005 (JP) 2005-104568

(51) Int. Cl. B60G 21/05; B60G 11/20

(52) U.S. Cl. 280/124.166; 280/124.128

(57) ABSTRACT

Disclosed is a torsion beam type rear suspension which comprises a pair of right and left trailing arms (2), a torsion beam (3), and a spring seat (6) disposed in a corner region defined at a junction between each of the lateral ends of the torsion beam and a rear portion (2c) of a corresponding one of the trailing arms to form a mounting seat for a coil spring (8). A vertical flange (13) is formed along a laterally inner edge (12) of the spring seat to have a longitudinally front edge extending vertically along a rear side surface of the torsion beam. The spring seat has a first region (7b) of disposed opposed to the corresponding trailing arm and fixed thereto approximately in its entirety, and a second region (16) disposed opposed to the torsion beam and fixed thereto only through the vertical flange. The torsion beam type rear suspension of the present invention can improve the supporting rigidity of the spring seat relative to a coil spring without increasing the rigidities of the spring seat and trailing arm themselves, while allowing the risk of stress concentration occurring at an end of the torsion beam to be reduced, so as to achieve increased chassis rigidity and adequately maintain suspension functions.

### BACKGROUND OF THE INVENTION

1. Field of the Invention

The present invention relates to a torsion beam type rear suspension.

2. Description of the Related Art

A torsion beam type suspension has a structure which comprises a torsion beam extending in a width or lateral direction of a vehicle body, and a pair of right and left arms each extending in a frontward/rearward or longitudinal direction of the vehicle body, wherein the torsion beam has opposite ends each connected to a longitudinally central portion of a corresponding one of the arms. This torsion beam type suspension is widely employed as a rear suspension for FF (front engine/front-wheel drive) compact vehicles. Generally, in the torsion beam type rear suspension employed in such FF compact vehicles, each of the arms is designed as a so-called trailing arm having a front end connected to a vehicle body and a rear end mounting a rear wheel, as disclosed in the following Patent Publication 1. Further, in the trailing arm type rear suspension, a coil spring is assembled therewith, and a spring seat is disposed in a corner region between the trailing arm and the torsion beam to mount the coil spring. Typically, this spring seat is fixed to the trailing arm (see, for example, the following Patent Publication 2).

[Patent Publication 1] Japanese Patent Laid-Open Publication No. 2001-321846

[Patent Publication 2] Japanese Patent Laid-Open Publication No. 2004-34866

A driving performance, such as drivability, stability or ride quality, of a vehicle, depends largely on rigidity of a so-called chassis. In cases where the rigidity of the chassis in a torsion beam type suspension is increased to obtain enhance driving performance, it is required to increase respective rigidities of the spring seat and the trailing arm supporting the spring seat. However, this technique has its own limits. Moreover, if the rigidities of the spring seat and the trailing arm are improperly increased, a balance in the torsion beam type suspension comprising the torsion beam and the pair of right and left trailing arms is likely to be spoiled.

### SUMMARY OF THE INVENTION

It is therefore an object of the present invention to provide a torsion beam type rear suspension having a spring seat which is fixed to not only a training aim but also a torsion beam in such a manner as to improve the supporting rigidity of the spring seat relative to a coil spring without increasing the rigidities of the spring seat and trailing arm themselves, while allowing the risk of stress concentration occurring at an end of the torsion beam to be reduced, so as to achieve increased chassis rigidity and adequately maintain suspension functions.

In order to achieve the above object, according a first aspect of the present invention, there is provided a torsion beam type rear suspension comprising: a pair of right and left trailing arms each of which extends in a longitudinal direction of a vehicle body and has a longitudinally front end supported relative to the vehicle body in a vertically swingable manner and a longitudinally rear end rotatably supporting a rear wheel; a torsion beam formed from a hollow pipe to have a closed and deformed section and designed to extend in a lateral direction of the vehicle body and have opposed lateral ends each connected to a longitudinally central portion of a corresponding one of the trailing arms; a spring seat disposed in a corner region defined at a junction between each of the lateral ends of the torsion beam and a rear portion of a corresponding one of the trailing arms to form a coil spring mounting seat; and a vertical flange formed on a laterally inward side of the spring seat to have a longitudinally front edge extending vertically along a rear side surface of the torsion beam. The spring seat has a first region of disposed opposed to the corresponding trailing arm and fixed thereto approximately in its entirety, and a second region disposed opposed to the torsion beam and fixed thereto only through the vertical flange.

As above, the torsion beam type rear suspension set forth in the first aspect of the present invention employs a structure where the vertically-extending vertical flange is formed on the laterally inward side of the spring seat or at a position spaced apart from the corresponding trailing arm in the laterally inward direction, and the torsion beam and the spring seat are fixed together only through the vertical flange. In other words, the remaining part of the second region disposed opposed to the torsion beam is unfixed relative to the torsion beam.

This structure makes it possible to fix the spring seat to not only the trailing arm but also the torsion beam. Thus, the supporting rigidity of the spring seat relative to a coil spring can be enhanced without increasing the rigidity of the spring seat and/or the trailing arm. Further, in the second region of the spring seat disposed opposed to the torsion beam, only the vertical flange extending vertically across the torsion beam is fixed to the torsion beam, but the remaining part of the second region is unfixed relative to the torsion beam. This makes it possible to reduce the risk of stress concentration occurring in the torsion beam.

These and other objects, features and advantages of the invention will become more apparent upon reading the following detailed description along with the accompanying drawings.

### BRIEF DESCRIPTION OF THE DRAWINGS

FIG. 1 is a fragmentary top plan view showing a right portion of a torsion beam type rear suspension according to one embodiment of the present invention.

FIG. 2 is a back view of the torsion beam type rear suspension in FIG. 1.

FIG. 3 is a perspective view showing the torsion beam type rear suspension in FIG. 1, viewed from a laterally inward side to a laterally outward side of a vehicle body.

FIG. 4 is a perspective view showing the torsion beam type rear suspension in FIG. 1, viewed from a laterally inward side to a laterally outward side of a vehicle body.

FIG. 5 is an explanatory fragmentary top plan view showing the torsion beam type rear suspension in FIG. 1.

### DETAILED DESCRIPTION OF THE PREFERRED EMBODIMENTS OF THE INVENTION

With reference to the accompanying drawings, an preferred embodiment of the present invention will now be described.

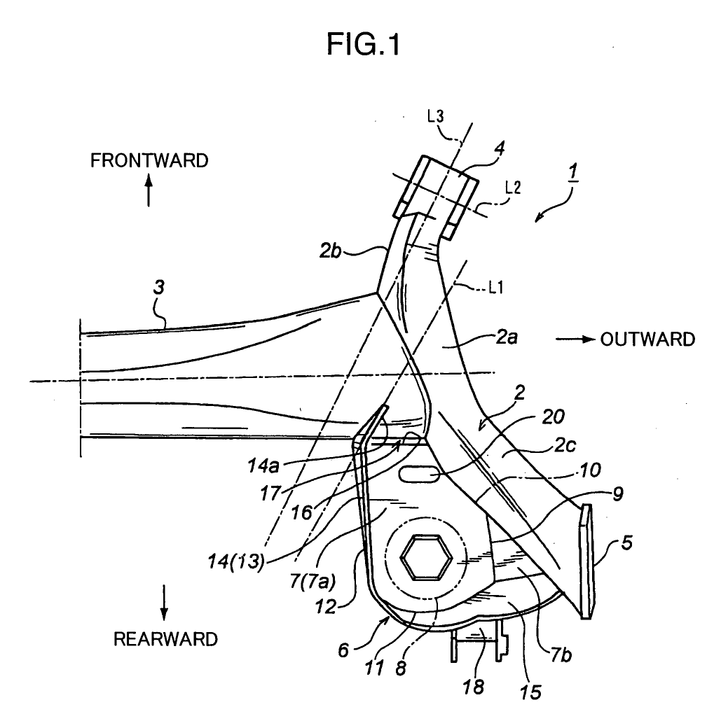

FIG. 1 is a fragmentary top plan view showing a right portion of a torsion beam type suspension according to one embodiment of the present invention, which is applied to a rear suspension for a vehicle. The torsion beam type rear suspension 1 comprises a pair of right and left trailing arms 2 disposed to extend in a frontward/rearward or longitudinal direction of a vehicle body, and a torsion beam 3 disposed to extend in a width or lateral direction of the vehicle body. Each of opposed lateral ends of the torsion beam 3 is welded to a longitudinally central portion 2a of a corresponding one of the trailing arms 2 to form a structure where the pair of trailing arms 2 are connected, respectively, to the opposed lateral ends of the torsion beam 3.

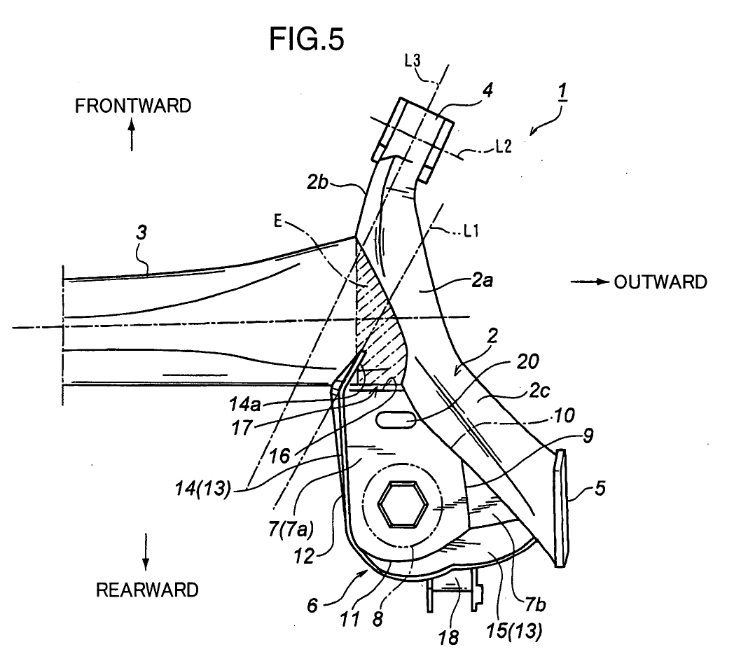

As with the structure disclosed in the Patent Publication 1 (Japanese Patent Laid-Open Publication No. 2001-321846), the torsion beam 3 is formed by pressing a hollow pipe to have a closed and deformed section. For example, this deformed section has a U shape with an opening facing downward. The torsion beam 3 is designed such that an area of the opening of the U-shaped section becomes larger at each of the lateral ends thereof, and becomes smaller at a laterally central portion thereof. That is, the torsion beam 3 is formed to have a width which gradually increases in a direction from the laterally central portion to each of the lateral ends in top plan view. Each of the lateral ends of the torsion beam 3 has an inclined edge extending obliquely rearward and laterally outward. That is, the lateral end of the torsion beam 3 is formed with an approximately right triangle-shaped enlarged portion E enlarged to have a longitudinally front end and a longitudinally rear end located laterally outward relative to the longitudinally front end in a top plan view (see FIG. 5). Based on this enlarged portion E, an overlapping area between the lateral end of the torsion beam 3 and the trailing arm 2 is greater at the longitudinally rear end than at the longitudinally front end. That is, the lateral end of the torsion beam 3 is formed to have higher rigidity at the longitudinally rear end than that at the longitudinally front end.

Each of the trailing arms 2 extending in the longitudinal direction of the vehicle body has an eye 4 at a front end thereof. The eye 4 is swingably supported by the vehicle body through a bushing (not shown). Further, the trailing arm 2 has a bracket 5 at a rear end thereof, and a rear wheel is rotatably supported by the trailing arm 2 through the bracket 5.

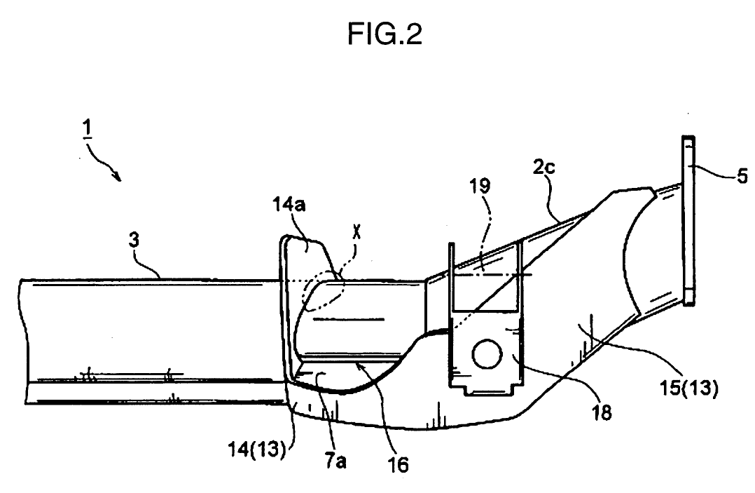

As shown in FIG. 1, the trailing arm 2 has a shape which is concavedly curved laterally outward in top plan view. That is, in top plan view, the trailing arm 2 has a front portion 2b extending from the eye 4 toward the central portion 2a with a laterally inward inclination, the central portion 2a extending toward the longitudinally rear portion with a slight laterally outward inclination, and the rear portion 2c extending from the central portion 2a to the bracket 5 with a large laterally outward inclination. FIG. 2 is a back view of a right portion of the torsion beam type suspension 1. As seen in FIG. 2, the trailing arm 2 is formed to extend obliquely upward from the central portion 2a to the bracket 5.

The torsion beam type suspension 1 includes a spring seat 6 disposed in a corner region between each of the lateral ends of the torsion beam 3 and the rear portion 2c of a corresponding one of the trailing arms 2.

The spring seat 6 is formed by subjecting a steel sheet to a press forming process. The spring seat 6 has a bottom wall 7. The torsion beam type rear suspension 1 includes a coil spring 8. The bottom wall 7 has a main bottom wall portion 7a extending approximately horizontally, and a mounting seat for the coil spring 8 is formed in a rear region of the main bottom wall portion 7a.

The bottom wall 7 includes an inclined portion 7b zoned relative to the main bottom wall portion 7a by a bead (bending line) 9, and the inclined portion 7b is disposed opposed to the rear end of the trailing arm 2. Specifically, the bead 9 extends linearly in the longitudinal direction of the vehicle body, and has a front end intersecting with the trailing arm 2 at a longitudinally intermediate position of the rear portion 2c thereof. The inclined portion 7b of the spring seat 6 extends from the bead 9 obliquely upward and laterally outward, and has a laterally outer edge in contact with the trailing arm 2.

As described above, the mounting seat for the coil spring 8 is formed in the rear portion of the bottom wall 7 of the spring seat 6. The rigidity of the rear portion of the bottom wall 7 is substantially increased by the bead 9 and the inclined portion 7b fixed to the trailing arm 2. Thus, the supporting rigidity of the spring seat 6 relative to the coil spring 8 can be ensured without providing an additional reinforcing member.

The spring seat 6 has a laterally outer edge which is welded to the trailing arm 2 in its entirety without forming a flange thereat. Specifically, the laterally outer edge 10 of the spring seat 6 is formed to extend along a side surface of the rear portion 2c of the trailing arm 2, and welded to the trailing arm 2 over the entire range thereof. As above, no flange is formed in this welded region between the spring seat 6 and the trailing arm 2. This can reduce an interference of the spring seat 6 relative to the trailing arm 2.

The spring seat 6 has a vertical flange 13 extending over a longitudinally rear edge 11 and a laterally inner edge 12. Specifically, the vertical flange 13 includes a first flange portion 14 extending longitudinally along the laterally inner edge 12 of the bottom wall 7, and a second flange portion 15 extending laterally along the longitudinally rear edge 11 of the main bottom wall portion 7a and the inclined portion 7b. The first and second flange portions 14, 15 are continued, and formed by bending the spring seat 6 upward. In this manner, a 3-dimensional structure consisting of the first flange portion 14, the second flange portion 15 and the inclined portion 7b is formed around the mounting seat for the coil spring 8 to provide sufficient rigidity to the mounting seat. This makes it possible to support a reaction force of the coil spring 8 by the spring seat 6 itself.

The first flange portion 14 extending longitudinally (in the longitudinal direction of the vehicle body) has a relatively low height. In contrast, the second flange portion 15 formed at the rear end of the spring seat 6 to extend laterally (in the lateral direction of the vehicle body) has a relatively large height. That is, the spring seat 6 is designed to have relatively low rigidity in a region thereof adjacent to the torsion beam 3 and have relatively high rigidity in a region thereof adjacent to the mounting seat for the coil spring 8.

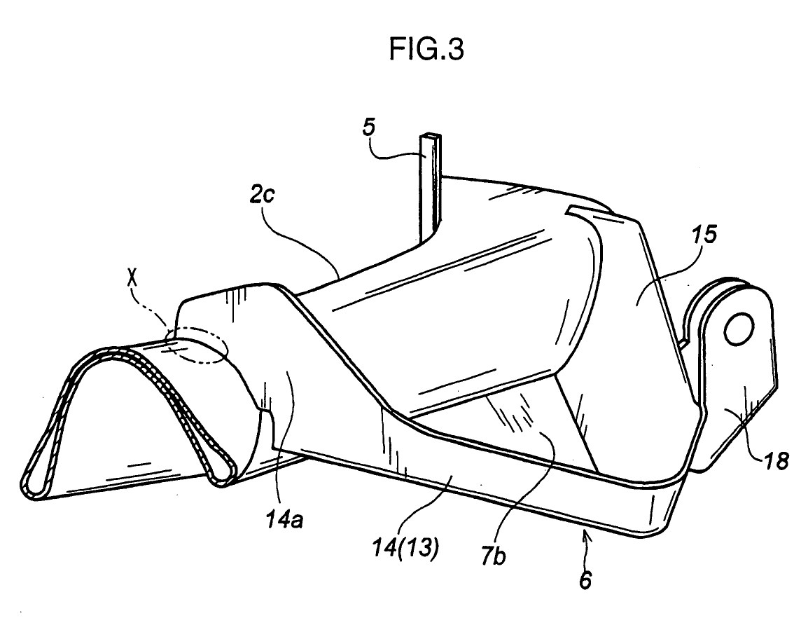

The first flange portion 14 extending longitudinally along the inner edge of the bottom wall 7 is formed to have a relatively low height, and a front end 14a, or a region adjacent to the torsion beam 3, of the first flange portion 14, extends upward and frontward. This front end 14 is formed to have a front edge to be in contact with the torsion beam 3. Specifically, the front end 14a of the first flange 14 has an upper edge enlarged upward, and the front edge of the front end 14a has a curved shape with a cutout in conformity to the rear side surface of the torsion beam 3. Further, the front edge of the first flange portion 14 is fixedly welded to the torsion beam 3 only through an upper region thereof or a region X surrounded by the elliptic two-dot chain line in FIGS. 2 and 3, but a lower region below the region X is not fixed to the torsion beam 3.

The upper region of the front edge of the first flange portion 14 welded to the torsion beam 3 extends obliquely frontward and laterally outward (or extends frontward with a laterally outward inclination). Preferably, this extension direction L1 is in parallel relation to the two-dot chain line 13 (in FIG. 1) orthogonal to an axis L2 of the eye 4 of the trailing arm 2 or a swing axis of the trailing arm 3. Further, it is preferable that the front edge of the first flange portion 14 is formed to allow the upper region thereof to be mounted on the upper surface of the torsion beam 3. In this case, the spring seat 6 is fixed to the torsion beam 3 while being hooked onto the torsion beam 3, so as to allow the spring seat 6 to be more reliably supported by the torsion beam 3.

The main bottom wall portion 7a of the spring seat 6 has a front edge 16 formed to have no flange and extend laterally along the torsion beam 3. Preferably, this front edge 16 is disposed slightly spaced apart from the torsion beam 3. In this embodiment, the front edge 16 is disposed to allow an elongated gap 17 extending along the torsion beam 3 to be formed between the front edge 16 and the torsion beam 3.

The vertical flange 13 formed along the inner edge 12 and the rear edge 11 of the spring seat 16 will be described in more detail below. The laterally outer edge of the second flange portion 15 is formed in a curved shape along the side surface of the trailing arm 2, and welded directly to the trailing arm 2 without a flange.

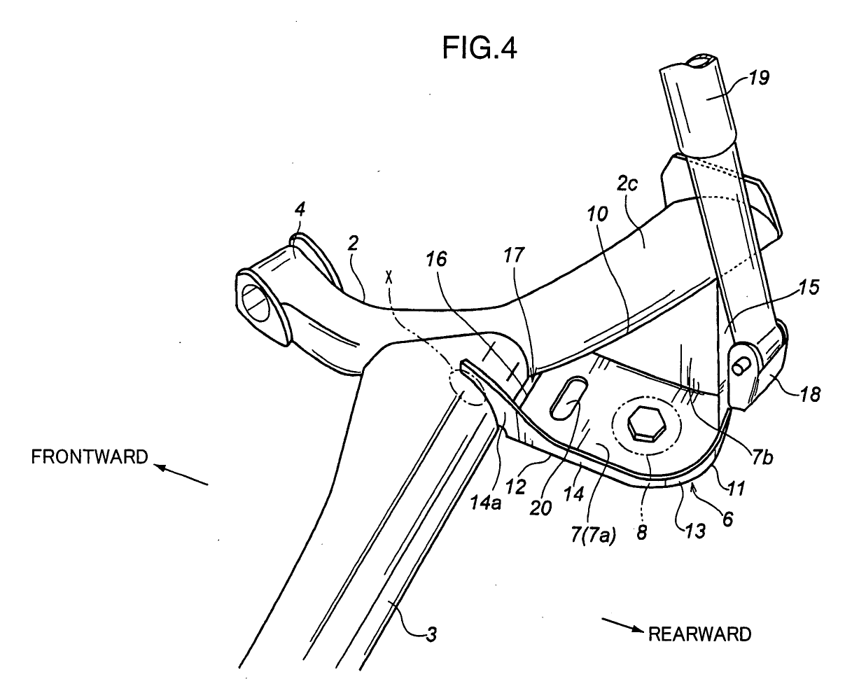

In the figures, the reference numeral 18 indicates a damper mounting bracket. This damper mounting bracket 18 is welded to a rear surface of the second flange portion 15. As shown in FIG. 4, a tube type damper 19 is mounted to the damper mounted bracket 18.

In a preferred embodiment of the present invention, an opening 20 is preferably formed in a longitudinally front region of the main bottom wall portion 7a of the spring seat 6 to serve as a means to reduce the rigidity of the longitudinally front region. Further, this opening 20 is preferably formed to extend laterally in approximately parallel relation to the torsion beam 3.

In the rear suspension 1 according to the above embodiment, the spring seat 6 is bent to form the vertical flange 13, and the vertically-extending front edge of the vertical flange 13 is welded to the torsion beam 3 to fix the spring seat 6 to the torsion beam 3. In this manner, the spring seat 6 fixed to not only the trailing arm 2 but also the torsion beam 3 can have enhanced supporting rigidity without the need for designing the trailing arm 2 and/or the spring seat 6 to be a high-rigidity member. Further, even if the spring seat 6 is fixed to the torsion beam 3, the above structure can eliminate an adverse affect on the torsion beam, such as torsional deformation.

In other words, if the front edge of the main bottom wall portion 7a of the spring seat 6 is simply fixed to the torsion beam 3, a movement of the lateral end of the torsion beam 3 is hindered by the spring seat 6 to substantially preclude the lateral end of the torsion beam 3 from fulfilling a suspension function. That is, an original function of the torsion beam suspension 1 comprising the pair of trailing arms 2 and the torsion beam 3 will be spoiled. Moreover, it is likely that a stress concentration occurs in the vicinity of a region of the laterally inner edge where the torsion beam 3 and the spring seat 6 are fixed together. In contrast, according to the above embodiment of the present invention, the front edge of the main bottom wall portion 7a of the spring seat 6 is not fixed to the torsion beam 3. This makes it possible to reduce the stress concentration while ensuring the suspension function.

Particularly, the structure where the upper region of the front edge of the vertical flange 13 to be fixed to the torsion beam 3 is formed to extend obliquely frontward and laterally outward, and the trailing arm 2 is formed in a shape concavedly curved laterally outward, as in the above embodiment, makes it possible to maintain a connection strength between the spring seat 6 and the torsion beam 3 against the swing movement of the trailing arm, and reduce the risk that the movement of the torsion beam 3 is hindered by the movement transmitted from the trailing arm 2 through the spring seat 6.

Further, the structure where the front edge of the main bottom wall portion 7a of the spring seat 6 is formed to have no flange so as to reduce the rigidity of the front portion of the spring seat 6 makes it possible to reduce the risk that the movement of the torsion beam 3 is hindered by the movement transmitted from the trailing arm 2 through the spring seat 6. Additionally, the opening 20 extending laterally may be formed in the front region of the main bottom wall portion 7a to facilitate a deformation in the front portion of the spring seat 6 so as to further increase the above effect.

Furthermore, as in the above embodiment, the 3-dimensional structure consisting of the bead 9, the inclined portion 7b, the first flange portion 14 and the second flange portion 15 may be formed around the mounting seat for the coil spring 8 to increase the rigidity of the mounting seat. Additionally, the second flange portion 15 may be formed to have a height greater than that of the first flange portion 14, and the laterally outer edge of the second flange portion 15 may be fixed to the trailing arm 2. In this case, a reaction force of the damper 19 and the coil spring 8 can be more reliably supported by the rear portion of the spring seat 6. This structure can also suppress the risk that a reaction force of the damper 19 and the coil spring 8 is imposed on the torsion beam 3 as an excessive torsional force through the spring seat 6.

A load from a reaction force of the coil spring 8 is applied from the spring seat 6 to the torsion beam 3 in such a manner as to twist the rear portion of the torsion beam 3 downward. According to the structure where the rigidity of the lateral end of the torsion beam 3 is arranged to be greater at the longitudinally rear end than at the longitudinally front end so as to achieve a favorable balance with the load, as in the above embodiment, the suspension performance of the torsion beam 3 can be ensured.

In sum, according a first aspect of the present invention, there is provided a torsion beam type rear suspension comprising: a pair of right and left trailing arms each of which extends in a longitudinal direction of a vehicle body and has a longitudinally front end supported relative to the vehicle body in a vertically swingable manner and a longitudinally rear end rotatably supporting a rear wheel; a torsion beam formed from a hollow pipe to have a closed and deformed section and designed to extend in a lateral direction of the vehicle body and have opposed lateral ends each connected to a longitudinally central portion of a corresponding one of the trailing arms; a spring seat disposed in a corner region defined at a junction between each of the lateral ends of the torsion beam and a rear portion of a corresponding one of the trailing arms to form a coil spring mounting seat; and a vertical flange formed on a laterally inward side of the spring seat to have a longitudinally front edge extending vertically along a rear side surface of the torsion beam. The spring seat has a first region of disposed opposed to the corresponding trailing arm and fixed thereto approximately in its entirety, and a second region disposed opposed to the torsion beam and fixed thereto only through the vertical flange.

As above, the torsion beam type rear suspension set forth in the first aspect of the present invention employs a structure where the vertically-extending vertical flange is formed on the laterally inward side of the spring seat or at a position spaced apart from the corresponding trailing arm in the laterally inward direction, and the torsion beam and the spring seat are fixed together only through the vertical flange. In other words, the remaining part of the second region disposed opposed to the torsion beam is unfixed relative to the torsion beam.

This structure makes it possible to fix the spring seat to not only the trailing arm but also the torsion beam. Thus, the supporting rigidity of the spring seat relative to a coil spring can be enhanced without increasing the rigidity of the spring seat and/or the trailing arm. Further, in the second region of the spring seat disposed opposed to the torsion beam, only the vertical flange extending vertically across the torsion beam is fixed to the torsion beam, but the remaining part of the second region is unfixed relative to the torsion beam. This makes it possible to reduce the risk of stress concentration occurring in the torsion beam.

In a preferred embodiment of the present invention, the spring seat has a laterally inward portion bent upward to provide the vertical flange. In this case, the vertical flange is formed with a longitudinally front end which has an inclined region extending obliquely frontward and laterally outward, and fixed to the torsion beam only through the inclined region. Preferably, this structure is employed in combination with a trailing arm formed in a shape which is concavedly curved laterally outward in top plan view. This structure makes it possible to reduce an adverse affect of a movement of the trailing arm on the torsion beam through the spring seat.

In a preferred embodiment of the present invention, the vertical flange is formed to allow the longitudinally front edge thereof to extend vertically over the rear side surface of the torsion beam in a contact manner. In this case, the vertical flange is fixed to the torsion beam only through an upper region of the front edge, but a lower region of the front edge of the vertical flange is not fixed to the torsion beam. That is, only the upper region of the vertical flange extending vertically across the torsion beam is fixed to the torsion beam. This makes it possible to reduce a contact area between the spring seat and the torsion beam so as to minimize an interference between the spring seat and the torsion beam. Preferably, the vertical flange is designed to fix the upper region to the torsion beam in such a manner as to be mounted on an upper surface of the torsion beam. In this case, the spring seat is fixed to the torsion beam while being hooked onto the torsion beam, so as to allow the spring seat to be more reliably supported by the torsion beam.

According to a second aspect of the present invention, there is provided a torsion beam type rear suspension comprising: a pair of right and left trailing arms each of which extends in a longitudinal direction of a vehicle body and has a longitudinally front end swingably supported relative to the vehicle body and a longitudinally rear end rotatably supporting a rear wheel; a torsion beam formed from a hollow pipe to have a closed and deformed section, and designed to extend in a lateral direction of the vehicle body and have opposed lateral ends each connected to a longitudinally central portion of a corresponding one of the trailing arms; and a spring seat disposed in a corner region defined at a junction between each of the lateral ends of the torsion beam and a rear portion of a corresponding one of the trailing arms. The spring seat has a bottom wall portion formed to serve as a coil spring mounting seat, and a rear end portion and a laterally inward portion which are bent upward to form a vertical flange. The spring seat has a first region disposed opposed to the corresponding trailing arm and fixed thereto approximately in its entirety, and a second region disposed opposed to the torsion beam and designed such that a remaining part of the second region other than the vertical flange is formed with no flange and unfixed relative to the torsion beam.

As above, in the torsion beam type rear suspension set forth in the secondt aspect of the present invention, the spring seat is fixed to not only the corresponding trailing arm but also the torsion beam. Thus, the supporting rigidity of the spring seat relative to a coil spring can be enhanced without increasing the rigidity of the spring seat and/or the trailing arm. Further, in the second region of the spring seat disposed opposed to the torsion beam, the remaining part other than the vertical flange is formed with no flange and unfixed relative to the torsion beam. Thus, the front end portion of the spring seat has relatively low rigidity. This makes it possible to reduce an adverse affect caused by fixing the spring seat to the torsion beam, particularly the risk of stress concentration occurring in the torsion beam.

In a preferred embodiment of the present invention, the vertical flange has a longitudinally front edge fixed to the torsion beam. That is, the spring seat is fixed to the torsion beam only through the vertical flange extending vertically across the torsion beam, but the remaining part of the second region opposed to the torsion beam is unfixed relative to the torsion beam.

In a preferred embodiment of the present invention, the vertical flange includes a first flange portion extending in the longitudinal direction of the vehicle body and having the longitudinally front edge fixed to the torsion beam, and a second flange portion formed at a longitudinally rear end of the spring seat to extend in the lateral direction of the vehicle body and fixed to the trailing arm. The second flange portion has a height greater than that of the first flange portion. Thus, the spring seat can have relatively low rigidity on a longitudinally front side thereof to be fixed to the torsion beam. This makes it possible to further reduce the risk of stress concentration in the torsion beam caused by fixing the spring seat to the torsion beam. The above structure is effectively used when the coil spring mounting seat is formed in a rear portion of the spring seat. Specifically, the second flange portion having a relatively large height can provide enhanced rigidity in the vicinity of the coil spring mounting seat.

In a particularly preferred embodiment of the present invention, for the purpose of facilitating a deformation in a longitudinally front portion of the spring seat, the bottom wall portion of the spring seat has a front region which includes a deformation facilitating zone extending approximately parallel to the torsion beam. Preferably, the deformation facilitating zone has an opening formed in the front region of the bottom wall portion to extend in the lateral direction of the vehicle body.

According to a third aspect of the present invention, there is provided a torsion beam type rear suspension comprising: a pair of right and left trailing arms each of which extends in a longitudinal direction of a vehicle body and has a longitudinally front end swingably supported relative to the vehicle body and a longitudinally rear end rotatably supporting a rear wheel; a torsion beam formed from a hollow pipe to have a closed and deformed section, and designed to extend in a lateral direction of the vehicle body and have opposed lateral ends each connected to a longitudinally central portion of a corresponding one of the trailing arms; and a spring seat disposed in a corner region defined at a junction between each of the lateral ends of the torsion beam and a rear portion of a corresponding one of the trailing arms, and fixed to the torsion beam and the corresponding trailing arm. The spring seat is provided with a coil spring mounting seat in a rear portion thereof, and a damper mounting seat at a longitudinally rear end thereof. The spring seat has a first region disposed opposed to the corresponding trailing arm and fixed thereto approximately in its entirety, and a second region disposed opposed to the torsion beam and fixed to the torsion beam only through a laterally inward zone thereof.

As above, in the torsion beam type rear suspension set forth in the third aspect of the present invention, the spring seat is fixed to not only the corresponding trailing arm but also the torsion beam. Thus, the supporting rigidity of the spring seat relative to a coil spring can be enhanced without increasing the rigidity of the spring seat and/or the trailing arm. Further, in the second region of the spring seat disposed opposed to the torsion beam, only the laterally inward zone is fixed to the torsion beam, but a laterally inward zone of the second region is not fixed to the torsion beam. This makes it possible to reduce an adverse affect caused by fixing the spring seat to the torsion beam, or suppress an excessive torsion force to be applied to the lateral end of the torsion beam due to a reaction force of a coil spring and/or a damper acting on the spring seat.

In a preferred embodiment of the present invention, the spring seat has a bead formed between the coil spring mounting seat and the first region opposed to the corresponding trailing arm to extend linearly in the longitudinal direction of the vehicle body. This bead makes it possible to provide enhanced strength in the spring seat without additionally providing a reinforcing member to the spring seat. Particularly, in the third aspect of the present invention, while the damper mounting seat is provided at the longitudinally rear end of the spring seat, the bead allows the spring seat to have rigidity sufficient to receiving a reaction force of a damper and a coil spring acting on the spring seat. Preferably, the laterally inward zone of the spring seat is formed with a first flange approximately parallel to the bead extending in the longitudinal direction of the vehicle body. A combination of the first flange and the bead can provide enhanced rigidity in the coil spring seat located therebetween. Further, the spring seat may include an inclined portion which extends from the bead obliquely upward and laterally outward, to more reliably obtain the above effect. That is, preferably, the spring seat is formed in a 3-dimensionally bent configuration having the above first flange, bead and inclined portion.

More preferably, the spring seat has a longitudinally rear end portion bent to form a second flange extending in the lateral direction of the vehicle body. This second flange may be formed to have a height greater than that of the first flange. This makes it possible to increase the rigidity of the rear portion of the spring seat provided with the coil spring mounting seat and the damper mounting seat while relatively reducing the rigidity of the front portion of the spring seat at low level, so as to reduce the adverse affect caused by fixing the spring seat to the torsion beam. Specifically, an excessive torsion force to be applied to the lateral end of the torsion beam due to a reaction force of an additional suspension component, such as a damper, can be suppressed. In view of achieving the object of the present invention, most preferably, the spring seat is designed to form the first and second flanges in a continuous manner, and fix a front end of the first flange and a laterally outer end of the second flange, respectively, to the torsion beam and the corresponding trailing arm.

According to a fourth aspect of the present invention, there is provided a torsion beam type rear suspension comprising: a pair of right and left trailing arms each of which extends in a longitudinal direction of a vehicle body and has a longitudinally front end swingably supported relative to the vehicle body and a longitudinally rear end rotatably supporting a rear wheel; a torsion beam formed from a hollow pipe to have a closed and deformed section, and designed to extend in a lateral direction of the vehicle body and have opposed lateral ends each connected to a longitudinally central portion of a corresponding one of the trailing arms; and a spring seat disposed in a corner region defined at a junction between each of the lateral ends of the torsion beam and a rear portion of a corresponding one of the trailing arms, and fixed to the torsion beam and the corresponding trailing arm. Each of the lateral ends of the torsion beam includes an enlarged portion enlarged laterally outward to have a longitudinally front end and a longitudinally rear end located laterally outward relative to the longitudinally front end in top plan view, and an overlapping area between the torsion beam and the trailing arm in the enlarged portion is larger at the longitudinally rear end than at the longitudinally front end.

As above, in the torsion beam type rear suspension set forth in the fourth aspect of the present invention, each of the lateral ends of the torsion beam is provided with the enlarged portion, and the enlarged portion is formed such that the longitudinally rear end is located laterally outward relative to the longitudinally front end, and an overlapping area between the enlarged portion and the trailing arm is larger at the longitudinally rear end than at the longitudinally front end. Thus, the rigidity of the lateral end of the torsion beam becomes greater at the longitudinally rear end than at the longitudinally front end.

In a structure where the spring seat is fixed to both the trailing arm and the torsion beam as in the present invention, a load from a reaction force of a coil spring is applied from the spring seat to the torsion beam in such a manner as to twist the longitudinally rear portion of the torsion beam downward. According to the above structure where the rigidity of the lateral end of the torsion beam is arranged to be greater at the longitudinally rear end than at the longitudinally front end, the rigidity of the torsion beam can be adjusted to achieve a favorable balance with the action of twisting the rear portion of the torsion beam downward. Thus, even if the spring seat is fixed additionally to the torsion beam, the suspension performance of the torsion beam can be ensured.

In a preferred embodiment of the present invention, the spring seat is fixed to a longitudinally rear portion of the torsion beam. Further, the spring seat has a region opposed to the torsion beam and formed with a vertical flange extending vertically in a laterally inward zone thereof. The region of the spring seat opposed to the torsion beam is fixed to the torsion beam only through the vertical flange. That is, a remaining part of the region of the spring seat opposed to the torsion beam other than the vertical flange is unfixed relative to the torsion beam. The above structure where the spring seat is fixed to the torsion beam through the vertically-extending vertical flange makes it possible to reduce the risk of stress concentration occurring in the lateral ends of the torsion beam. In other words, while the longitudinally front edge of the spring seat entirely fixed to the torsion beam causes difficulty in torsional deformation of the torsion beam and the risk of stress concentration on the boundary between the lateral end and a central portion of the torsion beam, the above structure where only the front edge of the vertically-extending vertical flange is fixed to the torsion beam can reduce the risk of the stress concentration.

This application claims priority from four Japanese Patent Application Serial Nos. 2005-104564, 2005-104565, 2005-104566 and 2005-104568, all of which were filed in Japan Patent Office on Mar. 31, 2005, thus the entire contents of which are incorporated by reference. Stated other way, it is deemed that the contents of aforementioned applications constitute part of this application.

Although the present invention has been described in term of specific exemplary embodiments, it will be appreciated that various changes and modifications may be made by those skilled in the art without departing from the spirits and scope of the invention, defined in the following claims.

What is claimed is:

1. A torsion beam type rear suspension comprising:
a pair of right and left trailing arms each of which extends in a longitudinal direction of a vehicle body and has a longitudinally front end supported relative to the vehicle body in a vertically swingable manner and a longitudinally rear end rotatably supporting a rear wheel;
a torsion beam formed from a hollow pipe to have a closed and deformed section, said torsion beam extending in a lateral direction of the vehicle body and having opposed lateral ends each connected to a longitudinally central portion of a corresponding one of said trailing arms;
a spring seat disposed in a corner region defined at a junction between each of the lateral ends of said torsion beam and a rear portion of a corresponding one of said trailing arms to form a coil spring mounting seat; and
a vertical flange formed on a laterally inward side of said spring seat to have a longitudinally front edge extending vertically along a rear side surface of said torsion beam,
wherein said spring seat has a first region of disposed opposed to said corresponding trailing arm and fixed thereto approximately in its entirety, and a second region disposed opposed to said torsion beam and fixed thereto only through said vertical flange.

2. The torsion beam type rear suspension according to claim 1, wherein said spring seat has a laterally inward portion bent upward to provide said vertical flange, wherein said vertical flange is formed with a longitudinally front end which has an inclined region extending obliquely frontward and laterally outward, and fixed to said torsion beam only through said inclined region.

3. The torsion beam type rear suspension according to claim 2, wherein said vertical flange is formed to allow the longitudinally front edge thereof to extend vertically over the rear side surface of said torsion beam in a contact manner, and fixed to said torsion beam only through an upper region of said front edge.

4. A torsion beam type rear suspension comprising:
a pair of right and left trailing arms each of which extends in a longitudinal direction of a vehicle body and has a longitudinally front end swingably supported relative to the vehicle body and a longitudinally rear end rotatably supporting a rear wheel;
a torsion beam formed from a hollow pipe to have a closed and deformed section, said torsion beam extending in a lateral direction of the vehicle body and having opposed lateral ends each connected to a longitudinally central portion of a corresponding one of said trailing arms; and
a spring seat disposed in a corner region defined at a junction between each of the lateral ends of said torsion beam and a rear portion of a corresponding one of said trailing arms, said spring seat having a bottom wall portion formed to serve as a coil spring mounting seat, and a rear end portion and a laterally inward portion which are bent upward to form a vertical flange,
wherein said spring seat has a first region disposed opposed to said corresponding trailing arm and fixed thereto approximately in its entirety, and a second region disposed opposed to said torsion beam and designed such that a remaining part of said second region other than said vertical flange is formed with no flange and unfixed relative to said torsion beam.

5. The torsion beam type rear suspension according to claim 4, wherein said vertical flange has a longitudinally front edge fixed to said torsion beam.

6. The torsion beam type rear suspension according to claim 5, wherein said vertical flange includes a first flange portion extending in the longitudinal direction of the vehicle body and having said longitudinally front edge fixed to said torsion beam, and a second flange portion formed at a longitudinally rear end of said spring seat to extend in the lateral direction of the vehicle body and fixed to said trailing arm, wherein said second flange portion has a height greater than that of said first flange portion.

7. The torsion beam type rear suspension according to claim 6, wherein said bottom wall portion of said spring seat has a front region which includes a deformation facilitating zone extending approximately parallel to said torsion beam.

8. The torsion beam type rear suspension according to claim 7, wherein said deformation facilitating zone has an opening formed in said bottom wall portion to extend approximately parallel to said torsion beam.

9. A torsion beam type rear suspension comprising:
a pair of right and left trailing arms each of which extends in a longitudinal direction of a vehicle body and has a longitudinally front end swingably supported relative to the vehicle body and a longitudinally rear end rotatably supporting a rear wheel;
a torsion beam formed from a hollow pipe to have a closed and deformed section, said torsion beam extending in a lateral direction of the vehicle body and having opposed lateral ends each connected to a longitudinally central portion of a corresponding one of said trailing arms; and
a spring seat disposed in a corner region defined at a junction between each of the lateral ends of said torsion beam and a rear portion of a corresponding one of said trailing arms, and fixed to said torsion beam and said corresponding trailing arm, said spring seat being provided with a coil spring mounting seat in a rear portion thereof, and a damper mounting seat at a longitudinally rear end thereof,
wherein said spring seat has a first region disposed opposed to said corresponding trailing arm and fixed thereto approximately in its entirety, and a second region disposed opposed to said torsion beam and fixed to said torsion beam only through a laterally inward zone thereof.

10. The torsion beam type rear suspension according to claim 9, wherein said spring seat has a bead formed between said coil spring mounting seat and said first region to extend linearly in the longitudinal direction of the vehicle body.

11. The torsion beam type rear suspension according to claim 10, wherein the laterally inward zone of said spring seat is bent to form a first flange extending in the longitudinal direction of the vehicle body and in approximately parallel relation to said bead.

12. The torsion beam type rear suspension according to claim 11, wherein said spring seat includes an inclined portion which extends from said bead obliquely upward and laterally outward and has a laterally outer edge fixed to said corresponding trailing arm.

13. The torsion beam type rear suspension according to claim 12, wherein said spring seat has a longitudinally rear end portion bent to form a second flange extending in the lateral direction of the vehicle body and having a height greater than that of said first flange.

14. A torsion beam type rear suspension comprising:
a pair of right and left trailing arms each of which extends in a longitudinal direction of a vehicle body and has a longitudinally front end swingably supported relative to the vehicle body and a longitudinally rear end rotatably supporting a rear wheel;
a torsion beam formed from a hollow pipe to have a closed and deformed section, said torsion beam extending in a lateral direction of the vehicle body and having opposed lateral ends each connected to a longitudinally central portion of a corresponding one of said trailing arms; and
a spring seat disposed in a corner region defined at a junction between each of the lateral ends of said torsion beam and a rear portion of a corresponding one of said trailing arms, and fixed to said torsion beam and said corresponding trailing arm,
wherein:
each of said lateral ends of said torsion beam includes an enlarged portion enlarged laterally outward to have a longitudinally front end and a longitudinally rear end located laterally outward relative to said longitudinally front end in top plan view; and
an overlapping area between said torsion beam and said trailing arm in said enlarged portion is larger at said longitudinally rear end than at said longitudinally front end.

15. The torsion beam type rear suspension according to claim 14, wherein said spring seat is fixed to a longitudinally rear portion of said torsion beam.

16. The torsion beam type rear suspension according to claim 15, wherein said spring seat has a region opposed to said torsion beam and formed with a vertical flange extending vertically in a laterally inward zone thereof, said region opposed to said torsion beam being fixed to said torsion beam only through said vertical flange.

17. A torsion beam type rear suspension comprising:
a pair of right and left trailing arms each of which extends in a longitudinal direction of a vehicle body and has a longitudinally front end supported relative to the vehicle body in a vertically swingable manner and a longitudinally rear end rotatably supporting a rear wheel;
a torsion beam formed from a hollow pipe to have a closed and deformed section, said torsion beam extending in a lateral direction of the vehicle body and having opposed lateral ends each connected to a longitudinally central portion of a corresponding one of said trailing arms; and
a spring seats disposed in a corner region defined at a junction between each of the lateral ends of said torsion beam and a rear portion of a corresponding one of said trailing arms, and provided with a coil spring mounting seat in a rear portion thereof and a damper mounting seat at a longitudinally rear end thereof, said spring seat including a bottom wall portion formed to serve as said coil spring mounting seat, and a rear end portion and a laterally inward portion bent upward to form a vertical flange,
wherein:
a portion of said vertical flange located in said laterally inward portion zone is formed to have a longitudinally front edge extending along a rear side surface of said torsion beam;
said spring seat has a first region disposed opposed to said corresponding trailing arm and fixed thereto approximately in its entirety, and a second region disposed opposed to said torsion beam and designed such that a remaining part of said second region other than said portion of said vertical flange is formed to have no flange, and said second region is fixed to said torsion beam only through said portion of said vertical flange;
each of said lateral ends of said torsion beam has an enlarged portion enlarged laterally outward to have a longitudinally front end and a longitudinally rear end located laterally outward relative to said longitudinally front end in top plan view; and
an overlapping area between said torsion beam and said trailing arm in said enlarged portion is larger at said longitudinally rear end than at said longitudinally front end.
